(19) United States
(12) Patent Application Publication
(10) Pub. No.: US 2025/0131442 A1
(43) Pub. Date: Apr. 24, 2025

(54) SYSTEMS AND METHODS FOR SCORING BANK DISPUTE CASES

(71) Applicant: Advantage Payment Services, Fargo, ND (US)

(72) Inventors: Jacqueline Rollins, Asheville, NC (US); Brian Ludemann, Waxhaw, NC (US)

(21) Appl. No.: 18/919,929

(22) Filed: Oct. 18, 2024

Related U.S. Application Data
(60) Provisional application No. 63/591,151, filed on Oct. 18, 2023.

(51) Int. Cl. G06Q 20/40

(52) U.S. Cl. CPC G06Q 20/4016

(57) ABSTRACT

A computing device receives a request to analyze a bank dispute case comprising one or more disputed transactions. For at least a first disputed transaction, for each of a plurality of data features, the computing device determines, based on details of the respective disputed transaction, a data feature value for the respective data feature. Based on the respective data feature value of each respective value, the computing device determines a denial probability and a approval probability for the respective disputed transaction. In response to receiving an indication of user input selecting the first disputed transaction, the computing device generates a graphical user interface comprising at least an indication of the denial probability for the first disputed transaction, an indication of the approval probability for the first disputed transaction, and at least one indication of an importance metric for a first data feature of the plurality of data features.

### RELATED APPLICATIONS

This application claims the benefit of U.S. Provisional Application No. 63/591,151, filed Oct. 18, 2023, the entire contents of which are incorporated herein by reference.

### TECHNICAL FIELD

The disclosure relates to predicting probabilities for bank dispute cases.

### BACKGROUND OF THE INVENTION

When a customer disputes transactions on a credit or debit card, is becomes the responsibility of the bank to determine whether there truly was fraudulent or other improper usage of the customer's account without that customer's authorization. Much of this work is left to the sole discretion of a case manager at the bank, individually analyzing whatever evidence may be present in that customer's account.

### SUMMARY OF THE INVENTION

In general, the disclosure is directed to systems and methods for scoring bank dispute cases. A computing device may receive a request to analyze a bank dispute case, wherein the bank dispute case includes one or more disputed transactions. For the disputed transactions in the dispute case, the computing device may assign values from the transaction details to data features that are fed into the predictive model. The computing device may create an approval or a denial score based on the data features. Predictions are explained via importance metrics, for instance, those that may be derived from Shapley values. In some instances, the Shapley values and importance metrics may be used to create the plain-text explanations that accompany the awarded approval or denial score. The importance metrics, case score, and transactions scores may create a method by which cases can be dispositioned. Either automatically or in response to receiving an indication of user input selecting a disputed transaction in a dispute case, the computing device may generate a graphical user interface that includes at least an indication of the approval or denial probability for the disputed transactions, and at least one data feature per case with its respective importance metric. The computing device may output a graphical user interface for display on a display device.

The objective of dispute case management is to process dispute cases quickly, accurately, and efficiently. The techniques described herein offer an integrated outcome model to assess probability of denials and approvals. This model interprets the financial data of closed transactions and predicts future results. These results can be used to reduce analysis time and increase efficiency, streamlining dispute case management. Furthermore, by presenting simplified scores and highlighting particular data within expansive user interfaces comprising large amounts of data, the techniques described herein may present improved user interfaces when compared to systems that merely output the data for a user to individually analyze. In examples where links are provided, the system provides a mechanism for a user to quickly navigate through these expansive files to the pieces of data that have a highest amount of influence on a case management dispute, further improving the user interfaces provided herein.

In a first example of the disclosure, a method is disclosed comprising receiving, by one or more processors, a request to analyze a bank dispute case, wherein the bank dispute case comprises one or more disputed transactions. The method further includes, for at least a first disputed transaction of the one or more disputed transactions, for each of a plurality of data features, determining, by the one or more processors and based at least in part on one or more details of the respective disputed transaction, a data feature value for the respective data feature, based at least in part on the respective data feature value of each respective value, determining, by the one or more processors, a denial probability for the respective disputed transaction, and based at least in part on the respective data feature value of each respective value, determining, by the one or more processors, an approval probability for the respective disputed transaction. The method also includes, in response to receiving an indication of user input selecting the first disputed transaction, generating, by the one or more processors, a graphical user interface comprising at least an indication of the denial probability for the first disputed transaction, an indication of the approval probability for the first disputed transaction, and at least one indication of an importance metric for a first data feature of the plurality of data features. The method further includes outputting, by the one or more processors and for display on a display device, the graphical user interface.

In another example, the disclosure is directed to a computing device comprising one or more processors configured to receive a request to analyze a bank dispute case, wherein the bank dispute case comprises one or more disputed transactions. The one or more processors are further configured to, for at least a first disputed transaction of the one or more disputed transactions, for each of a plurality of data features, determine, based at least in part on one or more details of the respective disputed transaction, a data feature value for the respective data feature, based at least in part on the respective data feature value of each respective value, determine a denial probability for the respective disputed transaction, and based at least in part on the respective data feature value of each respective value, determine an approval probability for the respective disputed transaction. In response to receiving an indication of user input selecting the first disputed transaction, the one or more processors are also configured to generate a graphical user interface comprising at least an indication of the denial probability for the first disputed transaction, an indication of the approval probability for the first disputed transaction, and at least one indication of an importance metric for a first data feature of the plurality of data features. The one or more processors are further configured to output, for display on a display device, the graphical user interface.

In another example, the disclosure is directed to a non-transitory computer-readable storage medium having stored thereon instructions that, when executed, cause one or more processors of a computing device to receive a request to analyze a bank dispute case, wherein the bank dispute case comprises one or more disputed transactions. The instructions, when executed, further cause the one or more processors to, for at least a first disputed transaction of the one or more disputed transactions, for each of a plurality of data features, determine, based at least in part on one or more details of the respective disputed transaction, a data feature value for the respective data feature, based at least in part on the respective data feature value of each respective value, determine a denial probability for the respective disputed transaction, and based at least in part on the respective data feature value of each respective value, determine an approval probability for the respective disputed transaction. The instructions, when executed, also cause the one or more processors to, in response to receiving an indication of user input selecting the first disputed transaction, generate a graphical user interface comprising at least an indication of the denial probability for the first disputed transaction, an indication of the approval probability for the first disputed transaction, and at least one indication of an importance metric for a first data feature of the plurality of data features. The instructions, when executed, further cause the one or more processors to output, for display on a display device, the graphical user interface.

In another example, the disclosure is directed to a system for performing any of the techniques described herein.

In another example, the disclosure is directed to a non-transitory computer-readable storage medium containing instructions that, when executed, cause one or more processors to perform any of the techniques described herein.

In another example, the disclosure is directed to an apparatus comprising means for performing any of the techniques described herein.

In another example, the disclosure is directed to a method comprising any of the techniques described herein.

In another example, the disclosure is directed to any of the techniques described herein.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings illustrate particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will be described with the appended drawings.

FIG. 1 is a conceptual diagram illustrating a computing device configured to generate and output a graphical user interface depicting generated scores for transactions in a bank dispute case, in accordance with the techniques described herein.

FIG. 2 is a block diagram illustrating a more detailed example of a computing device configured to perform the techniques described herein.

FIG. 3 is an example screenshot illustrating case-level scores for a bank dispute case, in accordance with the techniques described herein.

FIG. 4 is an example screenshot illustrating transaction-level scores for a bank dispute case, in accordance with the techniques described herein.

FIG. 5 is a flow diagram illustrating an example technique for generating predictive scores for a bank dispute transaction, in accordance with the techniques described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

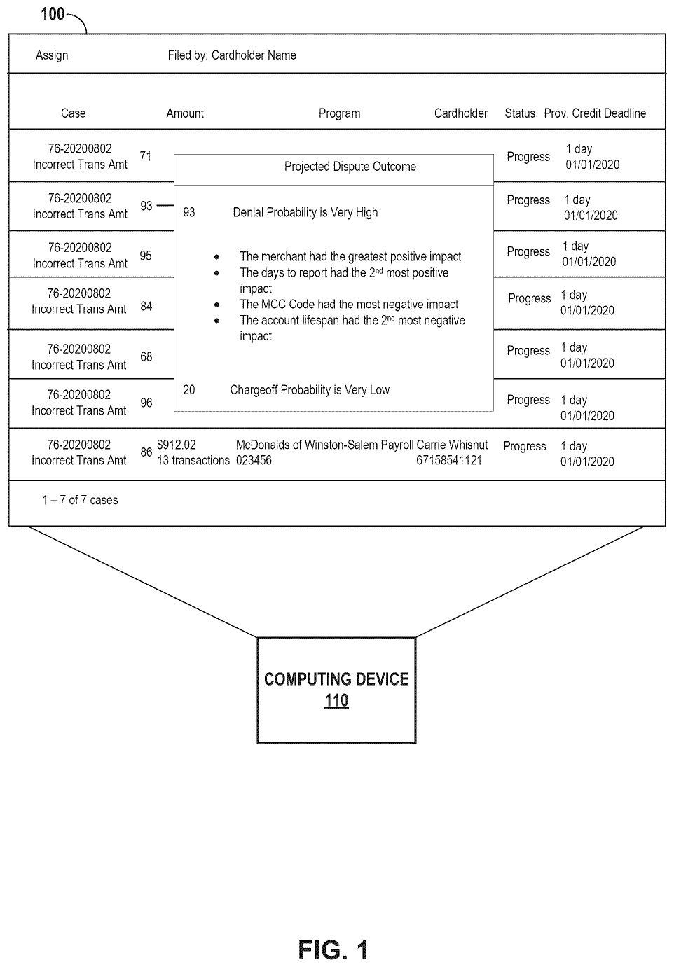

FIG. 1 is a conceptual diagram illustrating a computing device 110 configured to generate and output a graphical user interface 100 depicting generated scores for disputed transactions in a bank dispute case, in accordance with the techniques described herein. Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smart home component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

The objective of dispute case management is to process dispute cases quickly, accurately, and efficiently. The techniques described herein offer an integrated outcome model to assess probability of denials and approvals. This model interprets the financial data of closed transactions and predicts future results. These results can be used to reduce analysis time and increase efficiency, streamlining dispute case management. Furthermore, by presenting simplified scores and highlighting particular data within expansive user interfaces comprising large amounts of data, the techniques described herein may present improved user interfaces when compared to systems that merely output the data for a user to individually analyze. In examples where links are provided, the system provides a mechanism for a user to quickly navigate through these expansive files to the pieces of data that have a highest amount of influence on a case management dispute, further improving the user interfaces provided herein.

The techniques described herein utilize a business intelligence model to predict denial and approval probability. The model assesses the risk at both a case and transaction level. Analytics performed on closed cases are used to calculate future probability scores. The outcome probability model analyzes a range of data features to determine the score, including transaction amounts, number of disputed transactions per dispute case, and length of time between transaction settlement and report of dispute. These scores are easily identifiable and may be, in some instances, grouped into High, Average and Low risk categories. Supplemental descriptive text may summarize the definition and rationale of the score, allowing the case processor to quickly determine the appropriate course of action. For instance, the supplemental descriptive text may summarize Shapley values when such values are used in the determination of the score. Additionally, the scores may be used as criteria for the automatic assignment of cases to processors.

The techniques described herein include the integration of the outcome probability model to perform analysis at both a case and transaction level. The metrics may be aggregated in a fashion that simplifies analysis of the metrics, such as, in one example, a simplistic, consumable classification system of High, Average and Low.

Case processors may have access to enhanced tooltips with supporting text explaining the importance of each data feature comprised within the approval or denial scores and the rationale behind each probability score. The active queue may allow filtering and sorting of dispute cases by probability level and/or approval/denial score. Users in the dispute administrator role may have the ability to assign probability scores as parameters for the auto assignment of cases. In some instances, approval and denial scores may be two separate scores. In other instances, an approval score and a denial score may be a same score, or simply scores that, when added together, equal a constant number (e.g., 100).

Each record in the active queue may have an easily identifiable score with a tooltip that includes the definition and metrics utilized to generate the score. The case level score is also included in the header of each case. The active queue may be filtered and/or sorted by score. Within the transaction details of each case, there is a transaction level score and corresponding tooltip.

The disputes tab of user management may include criteria for denial and approval probability. The dispute administrator can select whether to auto assign cases to processors based on High, Average and/or Low probability scores. All probability options may be selected by default.

In the active queue, each case may have a score displayed next to the Case ID. The scores may be color-coded and represent High, Average or Low Denial probability level. The approval probability level is also calculated and displayed when the user engages the tooltip.

The case level scores may be calculated as an average of the individual transaction scores within the case. The following criteria may be used to calculate the score: total dollar value, number of disputed transactions, program name, program type, cardholder state, and number of days between transaction settlement and reporting the dispute, among other unlisted features.

Clicking the score opens a tooltip that explains the rationale of the score, based on the criteria listed above.

In the example of FIG. 1, the active queue may be filtered by denial and approval probability. The queue may be filtered by High, Average and Low for both denial and approval. In addition, the queue may be sorted both ascending and descending by denial probability via the column header.

The probability score is displayed with each open case in the case header. Clicking the score opens a tooltip that explains the rationale of the score, based on the criteria listed above.

In accordance with the techniques of this disclosure, computing device 110 may receive a request to analyze a bank dispute case, wherein the bank dispute case includes one or more disputed transactions. For at least a first disputed transaction of the one or more disputed transactions, for each of a plurality of data features, computing device 110 may determine, based at least in part on one or more details of the respective disputed transaction, a data feature value for the respective data feature. Based at least in part on the respective data feature value of each respective value, computing device 110 may determine a denial probability for the respective disputed transaction. Also based at least in part on the respective data feature value of each respective value, computing device 110 may determine a approval probability for the respective disputed transaction. Either automatically or in response to receiving an indication of user input selecting the first disputed transaction, computing device 110 may generate a graphical user interface 100 that includes at least an indication of the denial probability for the first disputed transaction, an indication of the approval probability for the first disputed transaction, at least one indication of an importance metric for a first data feature of the plurality of data features. Computing device 110 may output, for display on a display device, graphical user interface 100.

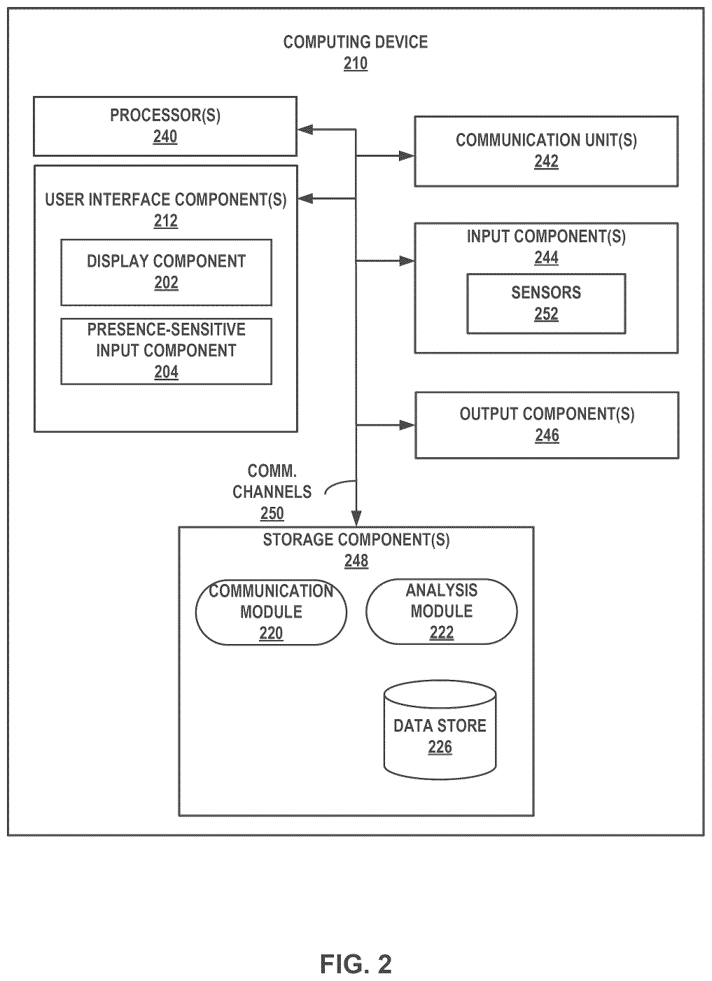

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smart home component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to analyze transactions in a bank dispute case. That is, processors 240 may implement functionality and/or execute instructions associated with computing device 210 to provide a recommendation or a score for a bank dispute case being analyzed by a bank.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to analyze transactions in a bank dispute case.

Communication module 220 may execute locally (e.g., at processors 240) to provide functions associated with receiving user input from input devices and generating and outputting graphical user interfaces. In some examples, communication module 220 may act as an interface to a remote service accessible to computing device 210. For example, communication module 220 may be an interface or application programming interface (API) to a remote server that performs the communication with other devices.

In some examples, analysis module 222 may execute locally (e.g., at processors 240) to provide functions associated with analyzing the transactions in a bank dispute case. In some examples, analysis module 222 may act as an interface to a remote service accessible to computing device 210. For example, analysis module 222 may be an interface or application programming interface (API) to a remote server that analyzes the transactions of the bank dispute case.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, and universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, oldata featurey sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may receive a request to analyze a bank dispute case, wherein the bank dispute case includes one or more disputed transactions.

For at least a first disputed transaction of the one or more disputed transactions, and for each of a plurality of data features, analysis module 222 may determine, based at least in part on one or more details of the respective disputed transaction, a data feature value for the respective data feature. In some instances, the plurality of data features may include any two or more of, but is not limited to, a total dollar value of the respective disputed transaction, a number of disputed transactions in the one or more disputed transactions, a program name of the respective disputed transaction, a program type of the respective disputed transaction, a cardholder state for the respective disputed transaction, a merchant state for the respective disputed transaction, a number of days since the respective disputed transaction, a good classification code for the respective disputed transaction, a network identification for the respective disputed transaction, a dispute reason for the respective disputed transaction, a point-of-sale entry mode for the respective disputed transaction, and a transaction code for the respective disputed transaction, among other things.

Based at least in part on the respective data feature value of each respective value, analysis module 222 may determine a denial probability for the respective disputed transaction. Also based at least in part on the respective data feature value of each respective value, analysis module 222 may determine an approval probability for the respective disputed transaction.

In addition, analysis module 222 may use Shapley values to create importance metrics by which descriptive text can be generated. This text is designed to explain which transaction details had the greatest impact on the model's approval or denial prediction.

Either automatically or in response to receiving an indication of user input selecting the first disputed transaction, communication module 220 may generate a graphical user interface including at least an indication of the denial probability for the first disputed transaction and an indication of the approval probability for the first disputed transaction.

In some instances analysis module 222 may determine the denial probability and the approval probability based further on a prediction model. In such instances, analysis module 222 may develop the prediction model using a normalization pipeline and Shapley values.

Communication module 220 may also generate the graphical user interface to include at least one indication of an importance metric for a first data feature of the plurality of data features. In some instances, the first data feature is the data feature of the plurality of data features having a highest value for the importance metric. The first data feature having the highest value for the importance metric indicates that the first data feature has a most extreme positively evaluated data feature value or a most extreme negatively evaluated data feature value compared to each other data feature of the plurality of data features.

In other words, the first data feature having the most extreme positively evaluated data feature value means the data feature value having a greatest influence on either decreasing the denial probability or increasing the approval probability compared to the data feature values for each other data feature of the plurality of data features. Conversely, the first data feature having the most extreme negatively evaluated data feature value means the data feature value having a greatest influence on either increasing the denial probability or decreasing the approval probability compared to the data feature values for each other data feature of the plurality of data features. In some instances, this measurement of extremes is determined using feature value-importance metric pairs for the data features within the predictive model. These pairs may include values that indicate the importance of the data feature for each prediction, allowing analysis module 222 to order the data features based on these values in order to determine which data features had the greatest influence on the ultimate score.

In some instances, communication module 220 may generate the indication of the data feature value to include a hyperlink that, when communication module 220 receives an indication of user input selecting the hyperlink, communication module 220 may update the graphical user interface to include details the data feature indicated by the respective indication. In some instances, communication module 220 may generate the indication of the data feature value for the first data feature to include a plain-language rationale explaining the data feature value for the first data feature. Additionally or alternatively, the indication of the data feature value in the graphical user interface may include transaction details, values for the data features, and importance metrics along with the descriptive text.

Communication module 220 may output, for display on a display device (such as any of output components 246 or UIC 212), the graphical user interface.

In some instances, based at least in part on the denial probability for of the first disputed transaction and the approval probability for the first disputed transaction, analysis module 222 may determine a transaction score for the first disputed transaction. In such instances, communication module 220 may generate the graphical user interface to further include an indication of the transaction score for the first disputed transaction.

In some instances, for each of the one or more disputed transactions, and for each of the plurality of data features, analysis module 222 may determine, based at least in part on the one or more details of the respective disputed transaction, the data feature value for the respective data feature. Based at least in part on the respective data feature value of each respective value, analysis module 222 may determine the denial probability for the respective disputed transaction. Based at least in part on the respective data feature value of each respective value, analysis module 222 may also determine the approval probability for the respective disputed transaction. Based at least in part on the denial probability for of the respective disputed transaction and the approval probability for the respective disputed transaction, analysis module 222 may determine a transaction score for the respective disputed transaction. In some instances, for the disputed transactions in the dispute case, analysis module 222 may determine the importance of each data feature in the dispute case with an importance metric using Shapley values. Analysis module 222 may aggregate these metrics and award the case an overall text description. Based on the values of each data feature and the importance metrics, analysis module 222 may determine a case disposition for the disputed transactions in a dispute case.

Based at least in part on the transaction score for each of the one or more disputed transactions, analysis module 222 may determine a case score for the bank dispute case. In such instances, communication module 220 may generate a second graphical user interface including at least an indication of the case score and one or more of an indication of a disputed transaction of the plurality of transactions having a most extreme denial probability, an indication a disputed transaction of the plurality of transactions having a most extreme approval probability, and an indication of a data feature of the plurality of data features having a most extreme positively evaluated data feature value or a most extreme negatively evaluated data feature value compared to each other data feature of the plurality of data features across each of the one or more disputed transactions. Communication module 220 may output, for display on the display device, the second graphical user interface.

In some such instances, the indications may include a hyperlink that, when communication module 220 receives an indication of user input selecting the hyperlink, communication module 220 may update the second graphical user interface to include details of the disputed transaction or the data feature indicated by the respective indication.

In some instances, analysis module 222 may determine the case score further based at least in part on one or more case-level data features. The one or more case-level data features may include any one or more of a total dollar value for the bank dispute case, a total number of transactions in the bank dispute case, a program name for the bank dispute case, a program type for the bank dispute case, a cardholder state for the bank dispute case, an indication of the cardholder participating in a government welfare or child support program, and a number of days between transaction settlements and a report date for the bank dispute case, among other things.

In some instances, communication module 220 may output, in the graphical user interface, a recommended disposition for the bank dispute case based at least in part on the denial probability and the approval probability for at least the first disputed transaction.

In some instances, communication module 220 may automatically send a disposition for the bank dispute case to a dispute processing system based at least in part on the denial probability and the approval probability for at least the first disputed transaction.

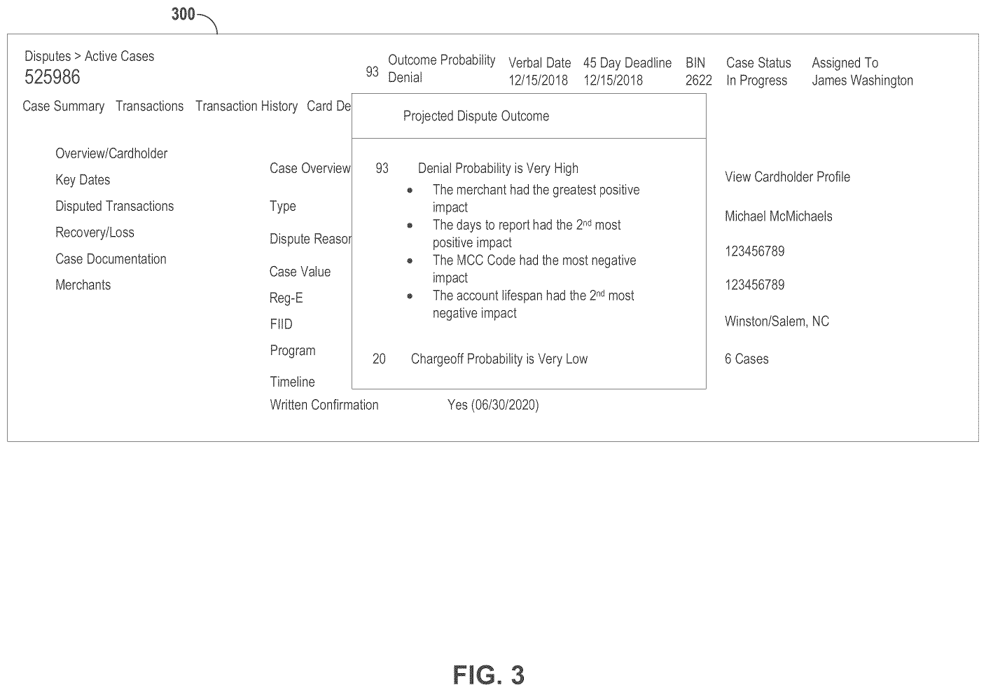

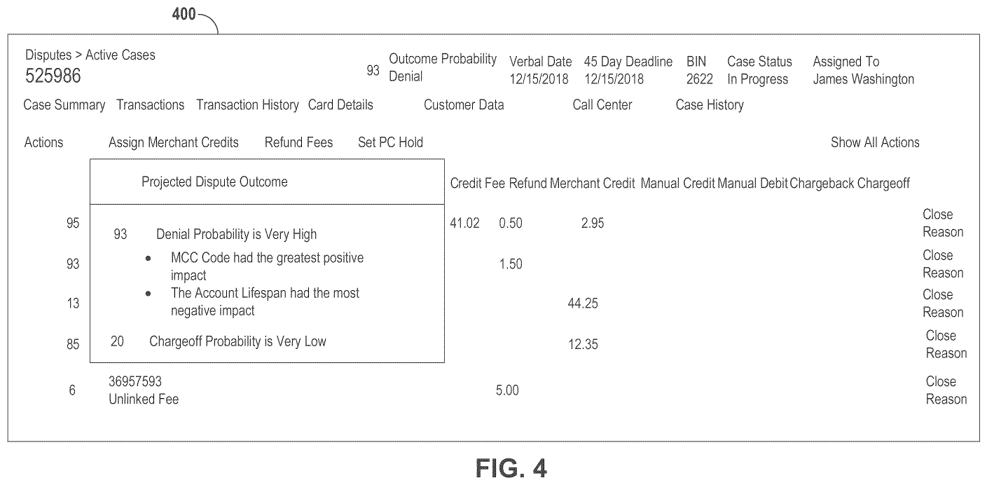

FIG. 3 is an example screenshot of graphical user interface 300 illustrating case-level scores for a bank dispute case, in accordance with the techniques described herein. When a report is initially run for a bank dispute case, a computing device may produce a case-level score in graphical user interface 300 and output graphical user interface for display on a display device. The case-level score may generally indicate whether the algorithm predicts the bank dispute case should result in a denial or an approval. In some instances, clicking on the score within the graphical user interface may produce an explanation of data features that had the greatest impact on the case-level score, such as the total case value exceeding a certain amount or a total number of transactions exceeding a certain amount. In other instances, this information is automatically included in graphical user interface 300 without requiring user input. In some instances, the user may also provide user input to navigate deeper into the analysis to view transaction-level scores, as shown in FIG. 4.

FIG. 4 is an example screenshot of graphical user interface 400 illustrating transaction-level scores for a bank dispute case, in accordance with the techniques described herein. Each transaction may have a score displayed next to the Transaction ID. The scores are color-coded and represent High, Average or Low Denial probability level. The approval risk level may also be calculated and displayed when the user engages the tooltip.

The following criteria may be used to calculate the score: MCC code, transaction amount, network ID, dispute reason, POS entry mode, merchant state, and transaction code, among other things.

Clicking the score opens a tooltip that explains the rationale of the score, based on the criteria listed above.

A dispute administrator may assign dispute attributes to case processors for the purpose of automatic case assignment through the “Get New Case” feature. When attributes are assigned, case processors may receive only those cases that match the designated attributes.

Within the Disputes tab of a case processor's user profile, there may be an option for outcome probability. When selected, the dispute administrator may assign High, Average and/or Low in each category, denial and/or writeoff. For example, if a case processor is assigned Approval=High, then the user may only receive cases with a denial probability score deemed highly probable for approval. These selections are optional and only available to users in the case processor role. The thresholds may also be variable, configurable by the user.

The system calculates seven levels of Probability, ranging from Very Low to Very High. To aid in case assignment and simplicity, these levels may be grouped into High, Average and Low.

In one example, the Denial Probability values be:

HIGH=69.8 through>91.3

AVERAGE=25.5 through 69.8

LOW=<3.1 through 25.5,

and the Approval Probability values may be:

HIGH=64.7 through>73.5

AVERAGE=24.7 through 53.7

LOW=<11.5 through 24.7

However, it should be noted that any indication of a range in this disclosure is only an example, and programmers or users may adjust these probabilities as they deem fit in order to satisfy the needs of the particular entity utilizing this technology.

Example Probability Classifications (taken only as an example, with alternate ranges being acceptable):

Denial Probability Classifications:

Very High (top 5th percentile): >91.3

High (top 15th percentile): 85.2-91.3

Slightly High (top 30th percentile): 69.8-85.2

Average: 25.5-69.8

Slightly Low (bottom 30th percentile): 10.3-25.5

Low (bottom 15th percentile): 3.1-10.3

Very Low (bottom 5th percentile): <3.1

Approval Probability Classifications:

Very High (top 5th percentile): >73.5

High (top 15th percentile): 64.7-73.5

Slightly High (top 30th percentile): 53.7-64.7

Average: 24.7-53.7

Slightly Low (bottom 30th percentile): 15.5-24.7

Low (bottom 15th percentile): 11.5-15.5

Very Low (bottom 5th percentile): <11.5

High Denial Probability Reasons (>80 Denial Probability)

Case level reasons

Total case value exceeds $10,000

Contains more than 75 disputed transactions

ReliaCard—Pennsylvania Unemployment program has a tendency for denials

ReliaCard—Arkansas Unemployment ADWS program has a tendency for denials

Cardholder waited more than 150 days to report this dispute

Transaction level reasons

MCC 6011 transactions are typically denied

MCC 5661 transactions are typically denied

POS entry mode 2 transactions are typically denied

POS entry mode 5 transactions are typically denied

High Approval Probability Reasons (>70 Approval Probability)

Case level reasons

Total case value less than $100

Contains less than 10 disputed transactions

Rapid PayCard Bancorp Visa program has a tendency for Approvals

Kroger Gift Internal Visa program has a tendency for Approvals

Kroger Gift Internal MC program has a tendency for Approvals

Rapid PayCard Meta MC program has a tendency for Approvals

Simplexes Gift—Visa FSV Direct program has a tendency for Approvals

Simplexes Gift—MC FSV Direct program has a tendency for Approvals

USB Corporate Rewards Visa w/o ATM program has a tendency for Approvals

USB Corporate Rewards Visa MYCA Site program has a tendency for Approvals

Cardholder reported this dispute within 7 days

Transaction level reasons

MCC 5818 transactions are typically charged off

MCC 5816 transactions are typically charged off

MCC 5968 transactions are typically charged off

MCC 5734 transactions are typically charged off

POS entry mode 0 transactions are typically charged off

POS entry mode 1 transactions are typically charged off

POS entry mode 90 transactions are typically charged off

POS entry mode 01 transactions are typically charged off

Null POS entry mode transactions are typically charged off

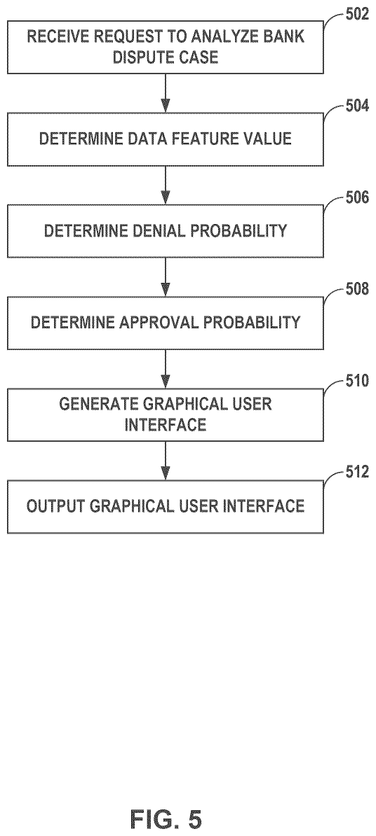

FIG. 5 is a flow chart illustrating an example mode of operation. The techniques of FIG. 5 may be performed by one or more processors of a computing device, such as computing device 110 of FIG. 1 and/or computing device 210 illustrated in FIG. 2. For purposes of illustration only, the techniques of FIG. 5 are described within the context of computing device 210 of FIG. 2, although computing devices having configurations different than that of computing device 210 may perform the techniques of FIG. 5.

In accordance with the techniques of this disclosure, communication module 220 may receive a request to analyze a bank dispute case, wherein the bank dispute case comprises one or more disputed transactions (502). For at least a first disputed transaction of the one or more disputed transactions, for each of a plurality of data features, analysis module 222 may determine, based at least in part on one or more details of the respective disputed transaction, a data feature value for the respective data feature (504). Based at least in part on the respective data feature value of each respective value, analysis module 222 may determine a denial probability for the respective disputed transaction (506). Based at least in part on the respective data feature value of each respective value, analysis module 222 may determine a approval probability for the respective disputed transaction (508). Either automatically or in response to receiving an indication of user input selecting the first disputed transaction, communication module 220 may generate a graphical user interface comprising at least an indication of the denial probability for the first disputed transaction, an indication of the approval probability for the first disputed transaction, and at least one indication of a data feature value for a first data feature of the plurality of data features, the first data feature comprising a data feature of the plurality of data features that has a most extreme positively evaluated data feature value or a most extreme negatively evaluated data feature value compared to each other data feature of the plurality of data features (510). Communication module 220 may output, for display on a display device, the graphical user interface (512).

Example 1: A method comprising: receiving, by one or more processors, a request to analyze a bank dispute case, wherein the bank dispute case comprises one or more disputed transactions; for at least a first disputed transaction of the one or more disputed transactions: for each of a plurality of data features, determining, by the one or more processors and based at least in part on one or more details of the respective disputed transaction, a data feature value for the respective data feature; based at least in part on the respective data feature value of each respective value, determining, by the one or more processors, a denial probability for the respective disputed transaction; and based at least in part on the respective data feature value of each respective value, determining, by the one or more processors, an approval probability for the respective disputed transaction; and in response to receiving an indication of user input selecting the first disputed transaction: generating, by the one or more processors, a graphical user interface comprising at least: an indication of the denial probability for the first disputed transaction, an indication of the approval probability for the first disputed transaction, and at least one indication of an importance metric for a first data feature of the plurality of data features; and outputting, by the one or more processors and for display on a display device, the graphical user interface.

Example 2: The method of claim 1, wherein the first data feature comprises a data feature of the plurality of data features having a highest value for the importance metric.

Example 3: The method of any one or more of claim 2, the first data feature having the highest value for the importance metric indicates that the first data feature has a most extreme positively evaluated data feature value or a most extreme negatively evaluated data feature value compared to each other data feature of the plurality of data features, wherein the first data feature having the most extreme positively evaluated data feature value comprises the data feature value having a greatest influence on either decreasing the denial probability or increasing the approval probability compared to the data feature values for each other data feature of the plurality of data features wherein the first data feature having the most extreme negatively evaluated data feature value comprises the data feature value having a greatest influence on either increasing the denial probability or decreasing the approval probability compared to the data feature values for each other data feature of the plurality of data features.

Example 4. The method of any one or more of claims 1-3, further comprising: based at least in part on the denial probability for of the first disputed transaction and the approval probability for the first disputed transaction, determining, by the one or more processors, a transaction score for the first disputed transaction, wherein the graphical user interface further includes an indication of the transaction score for the first disputed transaction.

Example 5. The method of any one or more of claims 1-4, further comprising: for each of the one or more disputed transactions: for each of the plurality of data features, determining, by the one or more processors and based at least in part on the one or more details of the respective disputed transaction, the data feature value for the respective data feature; based at least in part on the respective data feature value of each respective value, determining, by the one or more processors, the denial probability for the respective disputed transaction; based at least in part on the respective data feature value of each respective value, determining, by the one or more processors, the approval probability for the respective disputed transaction; and based at least in part on the denial probability for of the respective disputed transaction and the approval probability for the respective disputed transaction, determining, by the one or more processors, a transaction score for the respective disputed transaction; and based at least in part on the transaction score for each of the one or more disputed transactions, determining, by the one or more processors, a case score for the bank dispute case.

Example 6. The method of claim 5, further comprising: generating, by the one or more processors, a second graphical user interface comprising at least: an indication of the case score; and one or more of: an indication of a disputed transaction of the plurality of transactions having a most extreme denial probability; an indication a disputed transaction of the plurality of transactions having a most extreme approval probability; an indication of an importance metric for a data feature of the plurality of data features across each of the one or more disputed transactions; and outputting, by the one or more processors and for display on the display device, the second graphical user interface.

Example 7. The method of claim 6, wherein the indications comprise a hyperlink that, when the one or more processors receive an indication of user input selecting the hyperlink, the method further comprises updating, by the one or more processors, the second graphical user interface to include details of the disputed transaction or the data feature indicated by the respective indication.

Example 8. The method of any one or more of claims 5-7, wherein determining the case score is further based at least in part on one or more case-level data features, wherein the one or more case-level data features comprise one or more of: a total dollar value for the bank dispute case; a total number of transactions in the bank dispute case; a program name for the bank dispute case; a program type for the bank dispute case; a cardholder state for the bank dispute case; an indication of the cardholder participating in a government welfare or child support program; and a number of days between transaction settlements and a report date for the bank dispute case.

Example 9. The method of any one or more of claims 1-8, wherein the plurality of data features comprise two or more of: a total dollar value of the respective disputed transaction; a number of disputed transactions in the one or more disputed transactions; a program name of the respective disputed transaction; a program type of the respective disputed transaction; a cardholder state for the respective disputed transaction; a merchant state for the respective disputed transaction; a number of days since the respective disputed transaction; a good classification code for the respective disputed transaction; a network identification for the respective disputed transaction; a dispute reason for the respective disputed transaction; a point-of-sale entry mode for the respective disputed transaction; and a transaction code for the respective disputed transaction.

Example 10. The method of any one or more of claims 1-9, wherein the indication of the data feature value comprises a hyperlink that, when the one or more processors receive an indication of user input selecting the hyperlink, the method further comprises updating, by the one or more processors, the graphical user interface to include details the data feature indicated by the respective indication.

Example 11. The method of any one or more of claims 1-10, further comprising: outputting, by the one or more processors, in the graphical user interface, a recommended disposition for the bank dispute case based at least in part on the denial probability and the approval probability for at least the first disputed transaction.

Example 12. The method of any one or more of claims 1-11, wherein determining the denial probability and determining the approval probability are further based at least in part on a prediction model.

Example 13. The method of claim 12, further comprising: developing, by the one or more processors, the prediction model using a normalization pipeline and Shapley values.

Example 14. The method of any one or more of claims 1-13, wherein the indication of the data feature value for the first data feature comprises a plain-language rationale explaining the data feature value for the first data feature.

Example 15. The method of any one or more of claims 1-14, further comprising: automatically sending, by the one or more processors, a disposition for the bank dispute case to a dispute processing system based at least in part on the denial probability and the approval probability for at least the first disputed transaction.

Example 16. The method of any one or more of claims 1-15, wherein the graphical user interface includes indications of each data feature of the plurality of data features with a non-zero value as the importance metric.

Example 17. A computing device comprising one or more processors configured to: receive a request to analyze a bank dispute case, wherein the bank dispute case comprises one or more disputed transactions; for at least a first disputed transaction of the one or more disputed transactions: for each of a plurality of data features, determine, based at least in part on one or more details of the respective disputed transaction, a data feature value for the respective data feature; based at least in part on the respective data feature value of each respective value, determine a denial probability for the respective disputed transaction; and based at least in part on the respective data feature value of each respective value, determine an approval probability for the respective disputed transaction; and in response to receiving an indication of user input selecting the first disputed transaction: generate a graphical user interface comprising at least: an indication of the denial probability for the first disputed transaction, an indication of the approval probability for the first disputed transaction, and at least one indication of an importance metric for a first data feature of the plurality of data features; and output, for display on a display device, the graphical user interface.

Example 18. The computing device of claim 17, wherein the one or more processors are further configured to: for each of the one or more disputed transactions: for each of the plurality of data features, determine, based at least in part on the one or more details of the respective disputed transaction, the data feature value for the respective data feature; based at least in part on the respective data feature value of each respective value, determine the denial probability for the respective disputed transaction; based at least in part on the respective data feature value of each respective value, determine the approval probability for the respective disputed transaction; and based at least in part on the denial probability for of the respective disputed transaction and the approval probability for the respective disputed transaction, determine a transaction score for the respective disputed transaction; and based at least in part on the transaction score for each of the one or more disputed transactions, determine a case score for the bank dispute case.

Example 19. The computing device of claim 17, wherein the one or more processors are further configured to: output, in the graphical user interface, a recommended disposition for the bank dispute case based at least in part on the denial probability and the approval probability for at least the first disputed transaction.

Example 20. A non-transitory computer-readable storage medium having stored thereon instructions that, when executed, cause one or more processors of a computing device to: receive a request to analyze a bank dispute case, wherein the bank dispute case comprises one or more disputed transactions; for at least a first disputed transaction of the one or more disputed transactions: for each of a plurality of data features, determine, based at least in part on one or more details of the respective disputed transaction, a data feature value for the respective data feature; based at least in part on the respective data feature value of each respective value, determine a denial probability for the respective disputed transaction; and based at least in part on the respective data feature value of each respective value, determine an approval probability for the respective disputed transaction; and in response to receiving an indication of user input selecting the first disputed transaction: generate a graphical user interface comprising at least: an indication of the denial probability for the first disputed transaction, an indication of the approval probability for the first disputed transaction, and at least one indication of an importance metric for a first data feature of the plurality of data features; and output, for display on a display device, the graphical user interface.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

1. A method comprising:
receiving, by one or more processors, a request to analyze a bank dispute case, wherein the bank dispute case comprises one or more disputed transactions;
for at least a first disputed transaction of the one or more disputed transactions:
for each of a plurality of data features, determining, by the one or more processors and based at least in part on one or more details of the respective disputed transaction, a data feature value for the respective data feature;
based at least in part on the respective data feature value of each respective value, determining, by the one or more processors, a denial probability for the respective disputed transaction; and
based at least in part on the respective data feature value of each respective value, determining, by the one or more processors, an approval probability for the respective disputed transaction; and
in response to receiving an indication of user input selecting the first disputed transaction:
generating, by the one or more processors, a graphical user interface comprising at least:
an indication of the denial probability for the first disputed transaction,
an indication of the approval probability for the first disputed transaction, and
at least one indication of an importance metric for a first data feature of the plurality of data features; and
outputting, by the one or more processors and for display on a display device, the graphical user interface.

2. The method of claim 1, wherein the first data feature comprises a data feature of the plurality of data features having a highest value for the importance metric.

3. The method of any one or more of claim 2, the first data feature having the highest value for the importance metric indicates that the first data feature has a most extreme positively evaluated data feature value or a most extreme negatively evaluated data feature value compared to each other data feature of the plurality of data features,
wherein the first data feature having the most extreme positively evaluated data feature value comprises the data feature value having a greatest influence on either decreasing the denial probability or increasing the approval probability compared to the data feature values for each other data feature of the plurality of data features,
wherein the first data feature having the most extreme negatively evaluated data feature value comprises the data feature value having a greatest influence on either increasing the denial probability or decreasing the approval probability compared to the data feature values for each other data feature of the plurality of data features.

4. The method of claim 1, further comprising:
based at least in part on the denial probability for of the first disputed transaction and the approval probability for the first disputed transaction, determining, by the one or more processors, a transaction score for the first disputed transaction,
wherein the graphical user interface further includes an indication of the transaction score for the first disputed transaction.

5. The method of claim 1, further comprising:
for each of the one or more disputed transactions:
for each of the plurality of data features, determining, by the one or more processors and based at least in part on the one or more details of the respective disputed transaction, the data feature value for the respective data feature;
based at least in part on the respective data feature value of each respective value, determining, by the one or more processors, the denial probability for the respective disputed transaction;
based at least in part on the respective data feature value of each respective value, determining, by the one or more processors, the approval probability for the respective disputed transaction; and
based at least in part on the denial probability for of the respective disputed transaction and the approval probability for the respective disputed transaction, determining, by the one or more processors, a transaction score for the respective disputed transaction; and
based at least in part on the transaction score for each of the one or more disputed transactions, determining, by the one or more processors, a case score for the bank dispute case.

6. The method of claim 5, further comprising:
generating, by the one or more processors, a second graphical user interface comprising at least:
an indication of the case score; and
one or more of:
an indication of a disputed transaction of the plurality of transactions having a most extreme denial probability;
an indication a disputed transaction of the plurality of transactions having a most extreme approval probability;
an indication of an importance metric for a data feature of the plurality of data features across each of the one or more disputed transactions; and
outputting, by the one or more processors and for display on the display device, the second graphical user interface.

7. The method of claim 6, wherein the indications comprise a hyperlink that, when the one or more processors receive an indication of user input selecting the hyperlink, the method further comprises updating, by the one or more processors, the second graphical user interface to include details of the disputed transaction or the data feature indicated by the respective indication.

8. The method of claim 5, wherein determining the case score is further based at least in part on one or more case-level data features, wherein the one or more case-level data features comprise one or more of:
a total dollar value for the bank dispute case;
a total number of transactions in the bank dispute case;
a program name for the bank dispute case;
a program type for the bank dispute case;
a cardholder state for the bank dispute case;
an indication of the cardholder participating in a government welfare or child support program; and
a number of days between transaction settlements and a report date for the bank dispute case.

9. The method of claim 1, wherein the plurality of data features comprise two or more of:
a total dollar value of the respective disputed transaction;
a number of disputed transactions in the one or more disputed transactions;
a program name of the respective disputed transaction;
a program type of the respective disputed transaction;
a cardholder state for the respective disputed transaction;
a merchant state for the respective disputed transaction;
a number of days since the respective disputed transaction;
a good classification code for the respective disputed transaction;
a network identification for the respective disputed transaction;
a dispute reason for the respective disputed transaction;
a point-of-sale entry mode for the respective disputed transaction; and
a transaction code for the respective disputed transaction.

10. The method of claim 1, wherein the indication of the data feature value comprises a hyperlink that, when the one or more processors receive an indication of user input selecting the hyperlink, the method further comprises updating, by the one or more processors, the graphical user interface to include details the data feature indicated by the respective indication.

11. The method of claim 1, further comprising:
outputting, by the one or more processors, in the graphical user interface, a recommended disposition for the bank dispute case based at least in part on the denial probability and the approval probability for at least the first disputed transaction.

12. The method of claim 1, wherein determining the denial probability and determining the approval probability are further based at least in part on a prediction model.

13. The method of claim 12, further comprising:
developing, by the one or more processors, the prediction model using a normalization pipeline and Shapley values.

14. The method of claim 1, wherein the indication of the data feature value for the first data feature comprises a plain-language rationale explaining the data feature value for the first data feature.

15. The method of claim 1, further comprising:
automatically sending, by the one or more processors, a disposition for the bank dispute case to a dispute processing system based at least in part on the denial probability and the approval probability for at least the first disputed transaction.

16. The method of claim 1, wherein the graphical user interface includes indications of each data feature of the plurality of data features with a non-zero value as the importance metric.

17. A computing device comprising one or more processors configured to:
receive a request to analyze a bank dispute case, wherein the bank dispute case comprises one or more disputed transactions;
for at least a first disputed transaction of the one or more disputed transactions:
for each of a plurality of data features, determine, based at least in part on one or more details of the respective disputed transaction, a data feature value for the respective data feature;
based at least in part on the respective data feature value of each respective value, determine a denial probability for the respective disputed transaction; and
based at least in part on the respective data feature value of each respective value, determine an approval probability for the respective disputed transaction; and
in response to receiving an indication of user input selecting the first disputed transaction:
generate a graphical user interface comprising at least:
an indication of the denial probability for the first disputed transaction,
an indication of the approval probability for the first disputed transaction, and
at least one indication of an importance metric for a first data feature of the plurality of data features; and
output, for display on a display device, the graphical user interface.

18. The computing device of claim 17, wherein the one or more processors are further configured to:
for each of the one or more disputed transactions:
for each of the plurality of data features, determine, based at least in part on the one or more details of the respective disputed transaction, the data feature value for the respective data feature;
based at least in part on the respective data feature value of each respective value, determine the denial probability for the respective disputed transaction;
based at least in part on the respective data feature value of each respective value, determine the approval probability for the respective disputed transaction; and
based at least in part on the denial probability for of the respective disputed transaction and the approval probability for the respective disputed transaction, determine a transaction score for the respective disputed transaction; and
based at least in part on the transaction score for each of the one or more disputed transactions, determine a case score for the bank dispute case.

19. The computing device of claim 17, wherein the one or more processors are further configured to:
output, in the graphical user interface, a recommended disposition for the bank dispute case based at least in part on the denial probability and the approval probability for at least the first disputed transaction.

20. A non-transitory computer-readable storage medium having stored thereon instructions that, when executed, cause one or more processors of a computing device to:
receive a request to analyze a bank dispute case, wherein the bank dispute case comprises one or more disputed transactions;
for at least a first disputed transaction of the one or more disputed transactions:
for each of a plurality of data features, determine, based at least in part on one or more details of the respective disputed transaction, a data feature value for the respective data feature;
based at least in part on the respective data feature value of each respective value, determine a denial probability for the respective disputed transaction; and
based at least in part on the respective data feature value of each respective value, determine an approval probability for the respective disputed transaction; and
in response to receiving an indication of user input selecting the first disputed transaction:
generate a graphical user interface comprising at least:
an indication of the denial probability for the first disputed transaction,
an indication of the approval probability for the first disputed transaction, and
at least one indication of an importance metric for a first data feature of the plurality of data features; and
output, for display on a display device, the graphical user interface.
